(19) United States
(12) Patent Application Publication
(10) Pub. No.: US 2002/0140633 A1
(43) Pub. Date: Oct. 3, 2002

(54) Method and system to present immersion virtual simulations using three-dimensional measurement

(75) Inventors: Abbas Rafii, Los Altos, CA (US); Cyrus Bamji, Fremont, CA (US); Cheng-Feng Sze, Cupertino, CA (US)

Correspondence Address: Michael A. Kaufman, Esq., Flehr Hohbach Test Albritton & Herbert LLP, Four Embarcadero Center - Suite 3400, San Francisco, CA, 94111-4187, US

(73) Assignee: Canesta, Inc.

(21) Appl. No.: 09/777,778

(22) Filed: Feb. 5, 2001

Related U.S. Application Data
(60) Provisional application No. 60/180,473, filed on Feb. 3, 2000.

(51) Int. Cl. G09G 3/30

(52) U.S. Cl. 345/8

(57) ABSTRACT

A virtual simulation system generates an image of a virtual control on a display that may be a heads-up-display in a vehicle. The system uses three-dimensional range finding data to determine when a user is sufficiently close to the virtual control to “manipulate” the virtual control. The user “manipulation” is sensed non-haptically by the system, which causes the displayed control image to move in response to user manipulation. System output is coupled, linearly or otherwise, to an actual device having a parameter that is adjusted substantially in real-time by user-manipulation of the virtual image. System generated displays can be dynamic and change appearance when a user's hand is in close proximity. displays can disappear until needed, or can include menus and icons to be selected by the user who points towards or touches the virtual images. System generate images can include representation of the user for use in a training or gaming system.

### RELATION TO PREVIOUSLY FILED APPLICATION

Priority is claimed from U.S. provisional patent application, Ser. No. 60/180,473 filed Feb. 3, 2000, and entitled “User Immersion in Computer Simulations and Applications Using 3-D Measurement, Abbas Rafii and Cyrus Bamji, applicants.

### FIELD OF THE INVENTION

The present invention relates generally to so-called virtual simulation methods and systems, and more particularly to creating simulations using three-dimensionally acquired data so as to appear immerse the user in what is being simulated, and to permit the user to manipulate real objects by interacting with a virtual object.

### BACKGROUND OF THE INVENTION

So-called virtual reality systems have been computer implemented to mimic a real or a hypothetical environment. In a computer game context, for example, a user or player may wear a glove or a body suit that contains sensors to detect movement, and may wear goggles that present a computer rendered view of a real or virtual environment. User movement can cause the viewed image to change, for example to zoom left or right as the user turns. In some applications, the imagery may be projected rather than viewed through goggles worn by the user. Typically rules of behavior or interaction among objects in the virtual imagery being viewed are defined and adhered to by the computer system that controls the simulation. U.S. Pat. No. 5,963,891 to Walker (1999) entitled “System for Tracking Body Movements in a Virtual Reality System” discloses a system in which the user must wear a data-gathering body suit. U.S. Pat. No. 5,337,758 to Moore (1994) entitled “Spine Motion Analyzer and Method” discloses a sensor-type suit that can include sensory transducers and gyroscopes to relay back information as to the position of a user's body.

In training type applications, aircraft flight simulators may be implemented in which a pilot trainee (e.g., a user) views a computer-rendered three-dimensional representation of the environment while manipulating controls similar to those found on an actual aircraft. As the user manipulates the controls, the simulated aircraft appears to react, and the three-dimensional environment is made to change accordingly. The result is that the user interacts with the rendered objects in the viewed image.

But the necessity to provide and wear sensor-implemented body suits, gloves, helmets, or the necessity to wear goggles can add to the cost of a computer simulated system, and can be cumbersome to the user. Not only is freedom of motion restricted by such sensor-implemented devices, but is often necessary to provide such devices in a variety of sizes, e.g., large-sized gloves for adults, medium-sized gloves, small-sized gloves, etc. Further, only the one user wearing the body suit, glove, helmet, goggles can utilize the virtual system; onlookers for example see essentially nothing. An onlooker not wearing such sensor-laden garments cannot participate in the virtual world being presented and cannot manipulate virtual objects.

U.S. Pat. No. 5,168,531 to Sigel (1992 entitled “Real-time Recognition of Pointing Information From Video” discloses a luminosity-based two-dimensional information acquisition system. Sigel attempts to recognize the occurrence of a predefined object in an image by receiving image data that is convolved with a set of predefined functions, in an attempt to define occurrences of elementary features characteristic of the predefined object. But Sigel's reliance upon luminosity data requires a user's hand to exhibit good contrast against a background environment to prevent confusion with the recognition algorithm used.

Two-dimensional data acquisition systems such as disclosed by Korth in U.S. Pat. No. 5,767,842 (1998) entitled “Method and Device for Optical Input of Commands or Data use video cameras to image the user's hand or body. In some applications the images can be combined with computer-generated images of a virtual background or environment. Techniques including edge and shape detection and tracking, object and user detection and tracking, color and gesture tracking, motion detection, brightness and hue detection are sometimes used to try to identify and track user action. In a game application, a user could actually see himself or herself throwing a basketball in a virtual basketball court, for example, or shooting a weapon towards a virtual target. Such systems are sometimes referred to as immersion systems.

But two-dimensional data acquisition systems only show user motion in two dimension, e.g., x-axis, y-axis but not also z-axis. Thus if the user in real life would use a back and forth motion to accomplish a task, e.g., to throw a ball, in two-dimensional systems the user must instead substitute a sideways motion, to accommodate the limitations of the data acquisition system. In a training application, if the user were to pick up a component, rotate the component and perhaps move the component backwards and forwards, the acquisition system would be highly challenged to capture all gestures and motions. Also, such systems do not provide depth information, and such data that is acquired is luminosity-based and is very subject to ambient light and contrast conditions. An object moved against a background of similar color and contrast would be very difficult to track using such prior art two-dimensional acquisition systems. Further, such prior art systems can be expensive to implement in that considerable computational power is required to attempt to resolve the acquired images.

Prior art systems that attempt to acquire three-dimensional data using multiple two-dimensional video cameras similarly require substantial computing power, good ambient lighting conditions, and suffer from the limitation that depth resolution is limited by the distance separating the multiple cameras. Further, the need to provide multiple cameras adds to the cost of the overall system.

What is needed is a virtual simulation system in which a user can view and manipulate computer-generated objects and thereby control actual objects, preferably without requiring the user to wear sensor-implemented devices. Further, such system should permit other persons to see the virtual objects that are being manipulated. Such system should not require multiple image acquiring cameras (or equivalent) and should function in various lighting environments and should not be subject to inaccuracy due to changing ambient light and/or contrast. Such system should use Z-values (distance vector measurements) rather than luminosity data to recognize user interaction with system-created virtual images.

The present invention provides such a system.

### SUMMARY OF THE INVENTION

The present invention provides computer simulations in which user-interaction with computer-generated images of objects to be manipulated is captured in three-dimensions, without requiring the user to wear sensors. The images may be projected using conventional methods including liquid crystal displays and micro-mirrors.

A computer system renders objects that preferably are viewed preferably in a heads-up display (HUD). Although neither goggles nor special viewing equipment is required by the user in an HUD embodiment, in other applications the display may indeed include goggles, a monitor, or other display equipment. In a motor vehicle application, the HUD might be a rendering of a device for the car, e.g., a car radio, that is visible by the vehicle driver looking toward the vehicle windshield. To turn the virtual radio on, the driver would move a hand close as if to “touch” or otherwise manipulate the projected image of an on/off switch in the image. To change volume, the driver would “move” the projected image of a volume control. There is substantially instant feedback between the parameter change in the actual device, e.g., loudness of the radio audio, as perceived (e.g., heard) by the user, and user “movement” of the virtual control.

To change stations, the driver would “press” the projected image of a frequency control until the desired station is heard, whereupon the virtual control would be released by the user. Other displayed images may include warning messages concerning the state of the vehicle, or other environment, or GPS-type map displays that the user can control.

The physical location and movement of the driver's fingers in interacting with the computer-generated images in the HUD is determined non-haptically in three-dimensions by a three-dimensional range finder within the system. The three-dimensional data acquisition system operates preferably by transmitting light signals, e.g., energy in the form of laser pulses, modulated light beams, etc. In a preferred embodiment, return time-of-flight measurements between transmitted energy and energy reflected or returned from an object can provide (x,y,z) axis position information as to the presence and movement of objects. Such objects can include a user's hand, fingers, perhaps a held baton, in a sense-vicinity to virtual objects that are projected by the system. In an HUD application, such virtual objects may be projected to appear on (or behind or in front of) a vehicle windshield. Preferably ambient light is not relied upon in obtaining the three-dimensional position information, with the result that the system does not lose positional accuracy in the presence of changing light or contrast environments. In other applications, modulated light beams could instead be used.

When the user's hand (or other object evidencing user-intent) is within a sense-frustum range of the projected object, the three-dimensional range output data is used to change the computer-created image in accordance with the user's hand or finger (or other) movement. If the user hand or finger (or other) motion “moves” a virtual sliding radio volume control to the right within the HUD, the system will cause the virtual image of the slider to be moved to the right. At the same time, the volume on the actual radio in the vehicle will increase, or whatever device parameter is to be thus controlled. Range finding information is collected non-haptically, e.g., the user need not actually touch anything for (x,y,z) distance sensing to result.

The HUD system can also be interactive in the sense of displaying dynamic images as required. A segment of the HUD might be motor vehicle gages, which segment is not highlighted unless the user's fingers are moved to that region. On the other hand, the system can automatically create and highlight certain images when deemed necessary by the computer, for example a flashing “low on gas” image might be projected without user request.

In other applications, a CRT or LCD display can be used to display a computer rendering of objects that may be manipulated with a user's fingers, for example a virtual thermostat to control home temperature. “Adjusting” the image of the virtual thermostat will in fact cause the heating or cooling system for the home to be readjusted. Advantageously such display(s) can be provided where convenient to users, without regard to where physical thermostats (or other controls) may actually have been installed. In a factory training application, the user may view an actual object being remotely manipulated as a function of user movement, or may view a virtual image that is manipulated as a function of user movement, which system-detected movement causes an action object to be moved.

The present invention may also be used to implement training systems. In its various embodiments, the present invention presents virtual images that a user can interact with to control actual devices. Onlookers may see what is occurring in that the user is not required to wear sensor-equipped clothing, helmets, gloves, or goggles.

Other features and advantages of the invention will appear from the following description in which the preferred embodiments have been set forth in detail, in conjunction with the accompanying drawings.

### BRIEF DESCRIPTION OF THE DRAWINGS

FIG. 1 a heads-up display of a user-immersible computer simulation, according to the present invention;

FIG. 2A is a generic block diagram showing a system with which the present invention may be practiced;

FIG. 2B depicts clipping planes used to detect user-proximity to virtual images displayed by the present invention;

FIGS. 3A-3C depict use of a slider-type virtual control, according to the present invention;

FIG. 3D depicts exemplary additional images created by the present invention;

FIGS. 3E and 3F depict use of a rotary-type virtual control, according to the present invention;

FIGS. 3G, 3H, and 3I depict the present invention used in a manual training type application;

FIGS. 4A and 4B depict reference frames used to recognize virtual rotation of a rotary-type virtual control, according to the present invention; and

FIGS. 5A and 5B depict user-zoomable virtual displays useful to control a GPS device, according to the present invention.

### DETAILED DESCRIPTION OF THE PREFERRED EMBODIMENT

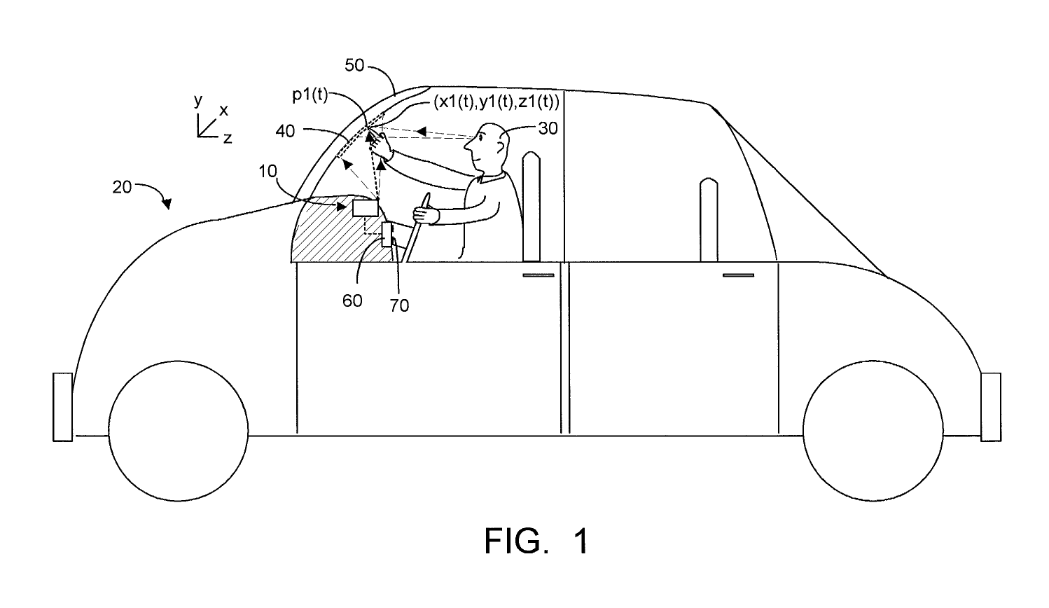

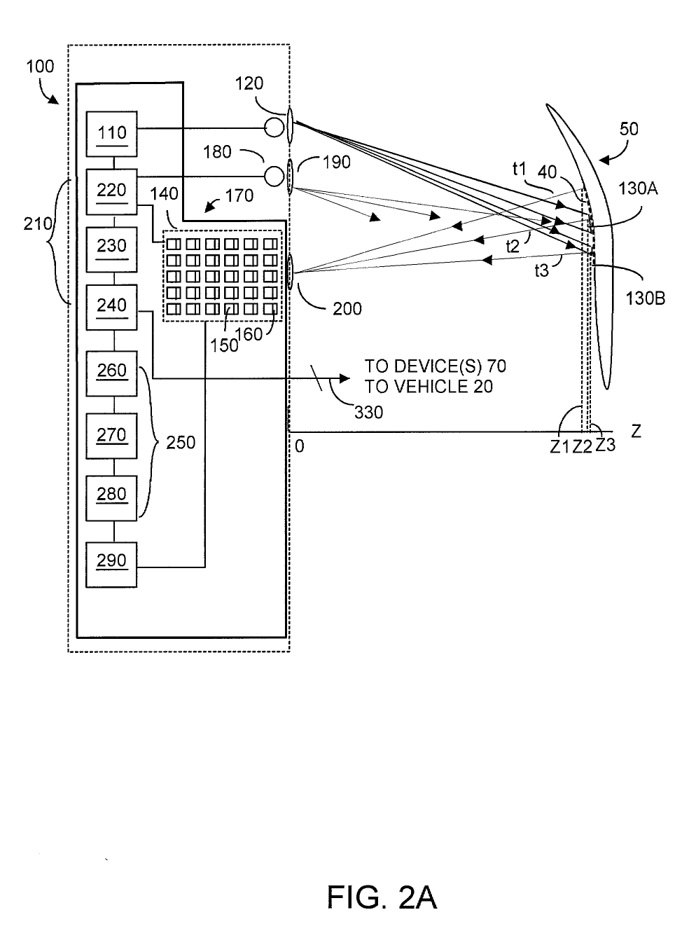

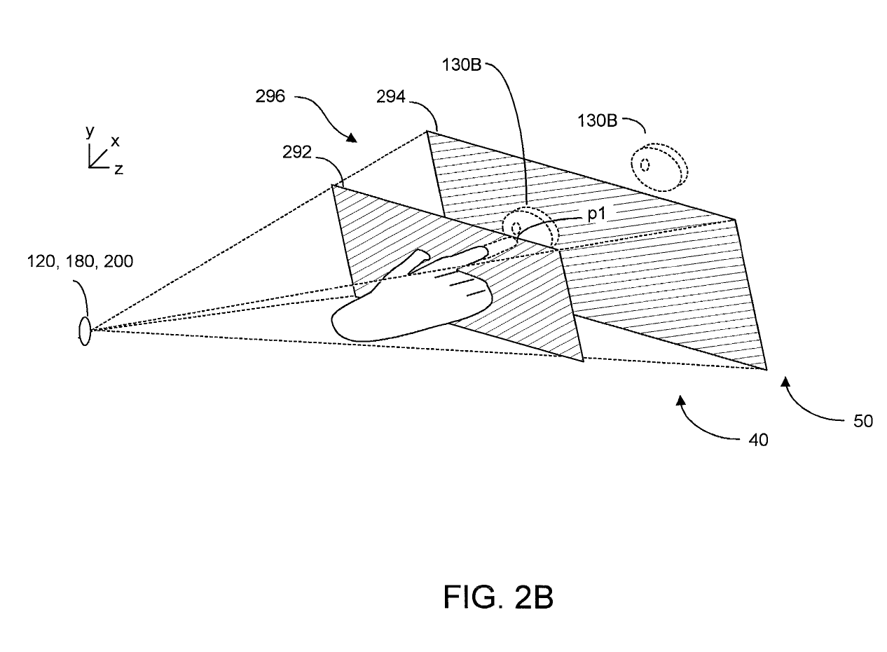

FIG. 1 depicts a heads-up display (HUD) application of a user-immersible computer simulation system, according to the present invention. The present invention 10 is shown mounted in the dashboard or other region of a motor vehicle 20 in which there is seated a user 30. Among other functions, system 10 computer-generates and projects imagery onto or adjacent an image region 40 of front windshield 50 of vehicle 20. Image projection can be carried out with conventional systems such as LCDs, or micro-mirrors. In this embodiment, user 30 can look ahead through windshield 50 while driving vehicle 20, and can also see any image(s) that are projected into region 40 by system 10. In this embodiment, system 10 may properly be termed a heads-up display system. Also shown in FIG. 1 are the three reference x,y,z axes. As described later herein with reference to FIG. 2B, region 40 may be said to be bounded in the z-axis by clipping planes.

User 30 is shown as steering vehicle 20 with the left hand while the right hand is near or touching a point p1(t) on or before an area of windshield within a detection range of system 10. By “detection range” it is meant that system 10 can determine in three-dimensions the location of point p1(t) as a function of time (t) within a desired proximity to image region 40. Thus, p1(t) may be uniquely defined by coordinates p1(t)=(x1(t),y1(t),z1(t)). Because system 10 has three-dimensional range finding capability, it is not required that the hand of user 30 be covered with a sensor-laden glove, as in many prior art systems. Further, since system 10 knows what virtual objects (if any) are displayed in image region 40, the interaction between the user's finger and such images may be determined. Detection in the present invention occurs non-haptically, that is it is not required that the user's hand or finger or pointer actually make physical contact with a surface or indeed anything in order to obtain the (x,y,z) coordinates of the hand, finger, or pointer.

FIG. 1 depicts a device 60 having at least one actual control 70 also mounted in vehicle 20, device 60 shown being mounted in the dashboard region of the vehicle. Device 60 may be an electronic device such as a radio, CD player, telephone, a thermostat control or window control for the vehicle, etc. As will be described, system 10 can project one or more images, including an image of device 60 or at least a control 70 from device 60.

Exemplary implementations for system 10 may be found in co-pending U.S. patent application Ser. No. 09/401,059 filed Sep. 22, 1999 entitled “CMOS-Compatible Three-Dimensional Image Sensor IC”, in co-pending U.S. patent application Ser. No. 09/502,499 filed Feb. 11, 2000 entitled “Method and Apparatus for Creating a Virtual Data Entry Device”, and in co-pending U.S. patent application Ser. No. 09/727,529 filed Nov. 28, 2000 entitled “CMOS-Compatible Three-Dimensional Image Sensor IC”. In that a detailed description of such systems may be helpful, applicants refer to and incorporate by reference each said pending U.S. patent application. The systems described in these patent applications can be implemented in a form factor sufficiently small to fit into a small portion of a vehicle dashboard, as suggested by FIG. 1 herein. Further, such systems consume low operating power and can provide real-time (x,y,z) information as to the proximity of a user's hand or finger to a target region, e.g., region 40 in FIG. 1. System 100, as used in the present invention, preferably collects data at a frame rate of at least ten frames per second, and preferably thirty frames per second. Resolution in the x-y plane is preferably in the 2 cm or better range, and in the z-axis is preferably in the 1 cm to 5 cm range.

A less suitable candidate for a multi-dimensional imaging system might be along the lines of U.S. Pat. No. 5,767,842 to Korth (1998) entitled “Method and Device for Optical Input of Commands or Data”. Korth proposes the use of conventional two-dimensional TV video cameras in a system to somehow recognize what portion of a virtual image is being touched by a human hand. But Korth's method is subject to inherent ambiguities arising from his reliance upon relative luminescence data, and upon adequate source of ambient lighting. By contrast, the applicants' referenced co-pending applications disclose a true time-of-flight three-dimensional imaging system in which neither luminescence data nor ambient light is relied upon.

However implemented, the present invention preferably utilizes a small form factor, preferably inexpensive imaging system that can find range distances in three dimensions, substantially in real-time, in a non-haptic fashion. FIG. 2A is an exemplary system showing the present invention in which the range finding system is similar to that disclosed in the above-referenced co-pending U.S. patent applications. Other non-haptic three-dimensional range finding systems could instead be used, however. In FIG. 2A, system 100 is a three-dimensional range finding system that is augmented by sub-system 110, which generates and can project via an optical system 120 computer-created object images such as 130A, 130B. Such projection may be carried out with LCDs or micro-mirrors, or with other components known in the art. In the embodiment shown, the images created can appear to be projected upon the surface of windshield 50, in front of, or behind windshield 50.

The remainder of system 100 may be as disclosed in the exemplary patent applications. An array 140 of pixel detectors 150 and their individual processing circuits 160 is provided preferably on an IC 170 that includes most if not all of the remainder of the overall system. A typical size for the array might be 100×100 pixel detectors 150 and an equal number of associated processing circuits 160. An imaging light source such as a laser diode 180 emits energy via lens system 190 toward the imaging region 40. At least some of the emitted energy will be reflected from the surface of the user's hand, finger, a held baton, etc., back toward system 100, and can enter collection lens 200. Alternatively, rather than use pulses of energy, a phase-detection based ranging scheme could be employed.

The time interval from start of a pulse of emitted light energy from source 190 to when some of the reflected energy is returned via lens 200 to be detected by a pixel diode detector in array 140 is measured. This time-of-flight measurement can provide the vector distance to the location on the windshield, or elsewhere, from which the energy was reflected. Clearly if a human finger (or other object) is within the imaging region 40, locations of the surface of the finger may, if desired, also be detected and determined.

System 100 preferably provides computer functions and includes a microprocessor or microcontroller system 210 that preferably includes a control processor 220, a data processor 230, and an input/output processor 240. IC 170 preferably further includes memory 250 having random access memory (RAM) 260, read-only memory (ROM) 270, and memory storing routine(s) 280 used by the present invention to calculate vector distances, user finger movement velocity and movement direction, and relationships between projected images and location of a user's finger(s). Circuit 290 provides timing, interface, and other support functions.

Within array 140, each preferably identical pixel detector 150 can generate data from to calculate Z distance to a point p1(t) in front of windshield 50, on the windshield surface, or behind windshield 50, or to an intervening object. In the disclosed applications, each pixel detector preferably simultaneously acquires two types of data that are used to determine Z distance: distance time delay data, and energy pulse brightness data. Delay data is the time required for energy emitted by emitter 180 to travel at the speed of light to windshield 40 or, if closer, a user's hand or finger or other object, and back to sensor array 140 to be detected. Brightness is the total amount of signal generated by detected pulses as received by the sensor array. It will be appreciated that range finding data is obtained without touching the user's hand or finger with anything, e.g., the data is obtained non-haptically.

As shown in FIG. 2B, region 40 may be considered to be bounded in the z-axis direction from a front clipping plane 292 and by a rear clipping plane 294. Rear clipping plane 292 may coincide with the z-axis distance from system 100 to the inner surface of windshield 50 (or other substrate in another application). The z-axis distance separating planes 292 and 294 represents the proximity range within which a user's hand or forefinger is to be detected with respect to interaction with a projected image, e.g. 130B. In FIG. 2B, the tip of the user's forefinger is shown as passing through plane 292 to “touch” image 130B, here projected to appear intermediate the two clipping planes.

In reality, clipping planes 292 and 294 will be curved and the region between these planes can be defined as an immersion frustum 296. As suggested by FIG. 2B, image 130B may be projected to appear within immersion frustum 296, or to appear behind (or outside) the windshield. If desired, the image could be made to appear in front of the frustum. The upper and lower limits of region 40 are also bounded by frustum 296 in that when the user's hand is on the car seat or on the car roof, it is not necessary that system 100 recognize the hand position with respect to any virtual image, e.g., 130B, that may be presently displayed. It will be appreciated that the relationship shown in FIG. 2B is a very intuitive way to provide feedback in that the user sees the image of a control 130B, reaches towards and appears to manipulate the control.

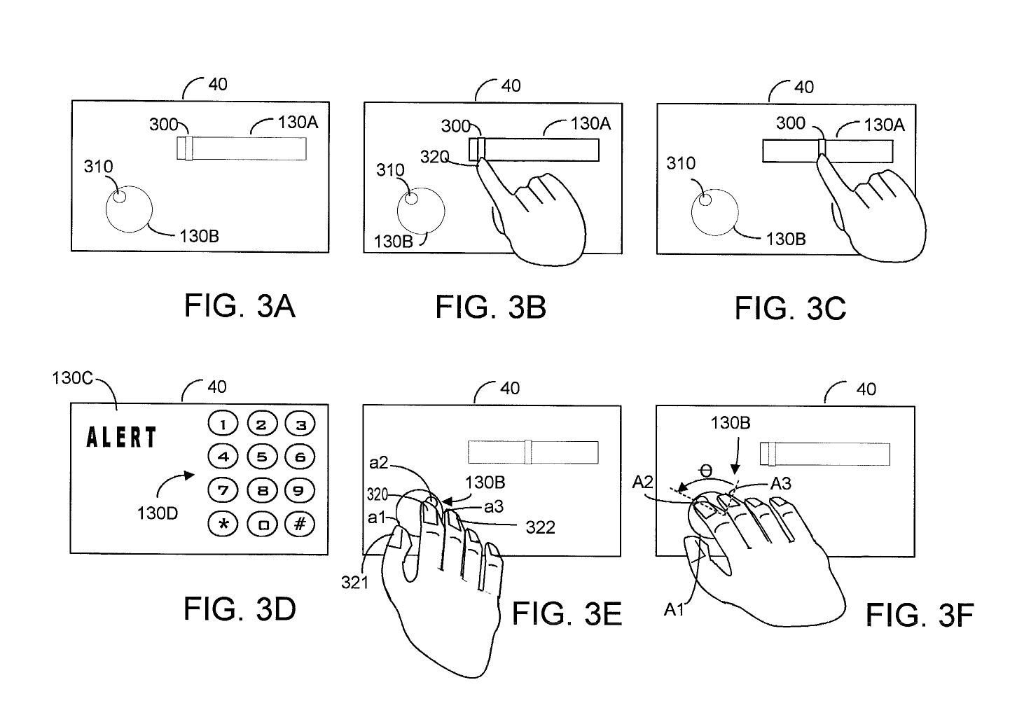

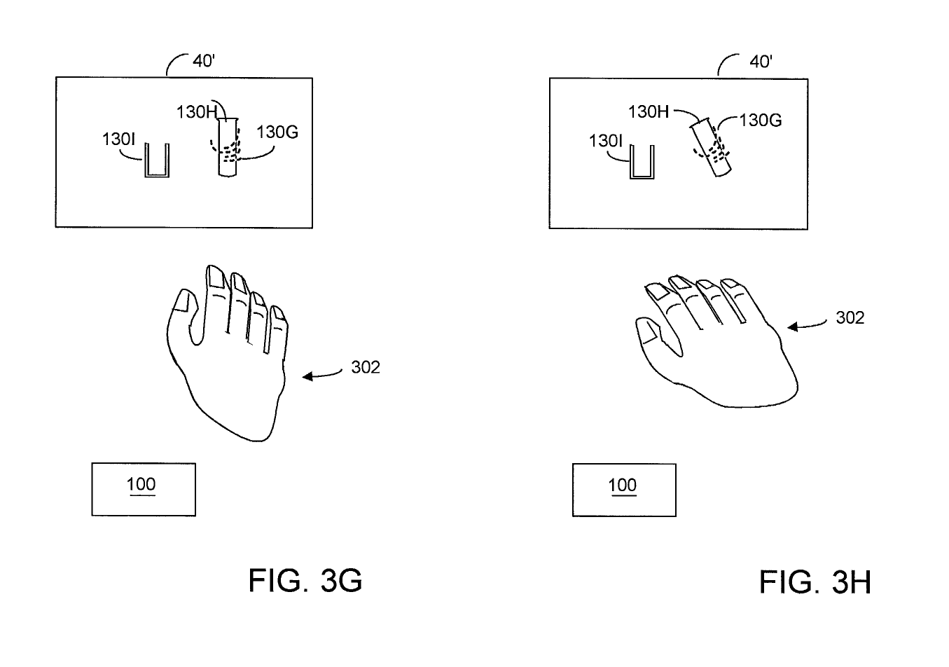

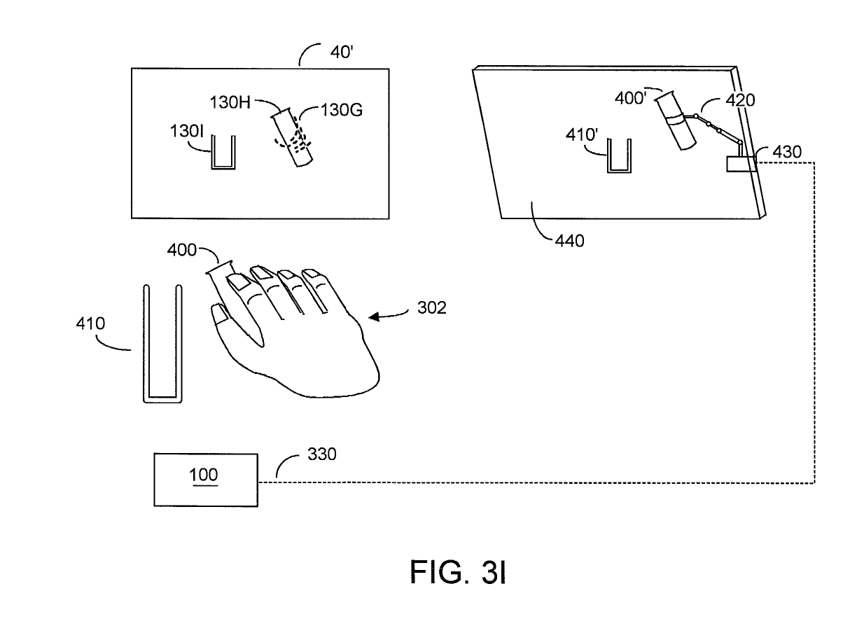

Three-dimensional range data is acquired by system 100 from examination of time-of-flight information between signals emitted by emitter 180 via optional lens 190, and return signals entering optional lens 200 and detected by array 140. Since system 100 knows a priori the distance and boundaries of frustum 296 and can detect when an object such as a user's forefinger is within the spaced bounded by the frustum. Software 290 recognizes the finger or other object is detected within this range, and system 100 is essentially advised of potential user intent to interact with any displayed images. Alternatively, system 100 can display a menu of image choices when an object such as a user's finger is detected within frustum 296. (For example, in FIG. 3D, display 130D could show icons rather than buttons, one icon to bring up a cellular telephone dialing display, another icon to bring up a map display, another icon to bring up vehicle control displays, etc.)

Software 290 attempts to recognize objects (e.g., user's hand, forefinger, perhaps arm and body, head, etc.) within frustum 206, and can detect shape (e.g., perimeter) and movement (e.g., derivative of positional coordinate changes). If desired, the user may hold a passive but preferably highly reflective baton to point to regions in the virtual display. Although system 100 preferably uses time-of-flight z-distance data only, luminosity information can aid in discerning objects and object shapes and positions.

Software 290 could cause a display that includes virtual representations of portions of the user's body. For example if the user's left hand and forefinger are recognized by system 100, the virtual display in region 40 could include a left hand and forefinger. If the user's left hand moved in and out or left and right, the virtual image of the hand could move similarly. Such application could be useful in a training environment, for example where the user is to pickup potentially dangerous items and manipulate them in a certain fashion. The user would view a virtual image of the item, and would also view a virtual image of his or her hand grasping the virtual object, which virtual object could then be manipulated in the virtual space in frustum 296.

FIGS. 3A, 3B, and 3C show portion 40 of an exemplary HUD display, as used by the embodiment of FIG. 1 in which system 100 projected image 130A is a slider control, perhaps a representation or token for an actual volume control 80 on an actual radio 70 within vehicle 20. As the virtual slider bar 300 is “moved” to the right, it is the function of the present invention to command the volume of radio 70 to increased, or if image 130A is a thermostat, to command the temperature within vehicle 20 to change, etc. Also depicted in FIG. 3A is a system 100 projected image of a rotary knob type control 130B having a finger indent region 310.

In FIG. 3A, optionally none of the projected images is highlighted in that the user's hand is not sufficiently close to region 40 to be sensed by system 100. Note, however, in FIG. 3B that the user's forefinger 320 has been moved towards windshield 50 (as depicted in FIG. 1), and indeed is within sense region 40. Further, the (x,y,z) coordinates of at least a portion of forefinger 320 are sufficiently close to the virtual slider bar 300 to cause the virtual slider bar and the virtual slider control image 130A to be highlighted by system 100. For example, the image may turn red as the user's foregoing “touches” the virtual slider bar. It is understood that the vector relationship in three-dimensions between the user's forefinger and region 40 is determined substantially in real-time by system 100, or by any other system able to reliably calculate distance coordinates in three-axes. In FIG. 3B the slider bar image has been “moved” to the right, e.g., as the user's forefinger moves left to right on the windshield, system 100 calculates the forefinger position, calculates that the forefinger is sufficiently close to the slider bar position to move the slider bar, and projects a revised image into region 40, wherein the slider bar has followed the user's forefinger.

At the same time, electrical bus lead 330 (see FIG. 2A), which is coupled to control systems in vehicle 20 including all devices 70 that are desired to at least have the ability to be virtually controlled, according to the present invention. Since system 100 is projecting an image associated, for example, with radio 70, the volume in radio 70 will be increased as the user's forefinger slides the computer rendered image of the slider bar to the right. Of course if the virtual control image 130 were say bass or treble, then bus lead 330 would command radio 70 to adjust bass or treble accordingly. Once the virtual slider bar image 300 has been “moved” to a desirable location by the user's forefinger, system 100 will store that location and continue to project, as desired by the user or as pre-programmed, that location for the slider bar image. Since the projected images can vary, it is understood that upon re-displaying slider control 130A at a later time (e.g., perhaps seconds or minutes or hours later), the slider bar will be shown at the last user-adjusted position, and the actual control function in device 70 will be set to the same actual level of control.

Turning to FIG. 3D, assume that no images are presently active in region 40, e.g., the user is not or has not recently moved his hand or forefinger into region 40. But assume that system 100, which is coupled to various control systems and sensors via bus lead 330, now realizes that the gas tank is nearly empty, or that tire pressure is load, or that oil temperature is high. System 100 can now automatically project an alert or warning image 130C, e.g., “ALERT” or perhaps “LOW TIRE PRESSURE”, etc. As such, it will be appreciated that what is displayed in region 40 by system 100 can be both dynamic and interactive.

FIG. 3D also depicts another HUD display, a virtual telephone dialing pad 130D, whose virtual keys the user may “press” with a forefinger. In this instance, device 70 may be a cellular telephone coupled via bus lead 130 to system 100. As the user's forefinger touches a virtual key, the actual telephone 70 can be dialed. Software, e.g., routine(s) 280, within system 100 knows a priori the location of each virtual key in the display pad 130D, and it is a straightforward task to discern when an object, e.g., a user's forefinger, is in close proximity to region 40, and to any (x,y,z) location therein. When a forefinger hovers over a virtual key for longer than a predetermined time, perhaps 100 ms, the key may be considered as having been “pressed”. The “hovering” aspect may be determined, for example, by examining the first derivative of the (x(t),y(t),z(t)) coordinates of the forefinger. When this derivative is zero, the user's forefinger has no velocity and indeed is contacting the windshield and can be moved no further in the z-axis. Other techniques may instead be used to determine location of a user's forefinger (or other hand portion), or a pointer held by the user, relative to locations within region 40.

Referring to FIG. 3E, assume that the user wants to “rotate” virtual knob 130B, perhaps to change frequency on a radio, to adjust the driver's seat position, to zoom in or zoom out on a projected image of a road map, etc. Virtual knob 130B may be “grasped” by the user's hand, using for example the right thumb 321, the right forefinger 320, and the right middle finger 322, as shown in FIG. 3E. By “grasped” it is meant that the user simply reaches for the computer-rendered and projected image of knob 130B as though it were a real knob. In a preferred embodiment, virtual knob 130B is rendered in a highlight color (e.g., as shown by FIG. 3E) when the user's hand (or other object) is sufficiently close to the area of region 40 defined by knob 130B. Thus in FIG. 3A, knob 130B might be rendered in a pale color, since no object is in close proximity to that portion of the windshield. But in FIG. 3E, software 280 recognizes from acquired three-dimensional range finding data that an object (e.g., a forefinger) is close to the area of region 40 defined by virtual knob 130B. Accordingly in FIG. 3E, knob 130B is rendered in a more discernable color and/or with bolder lines than is depicted in FIG. 3A.

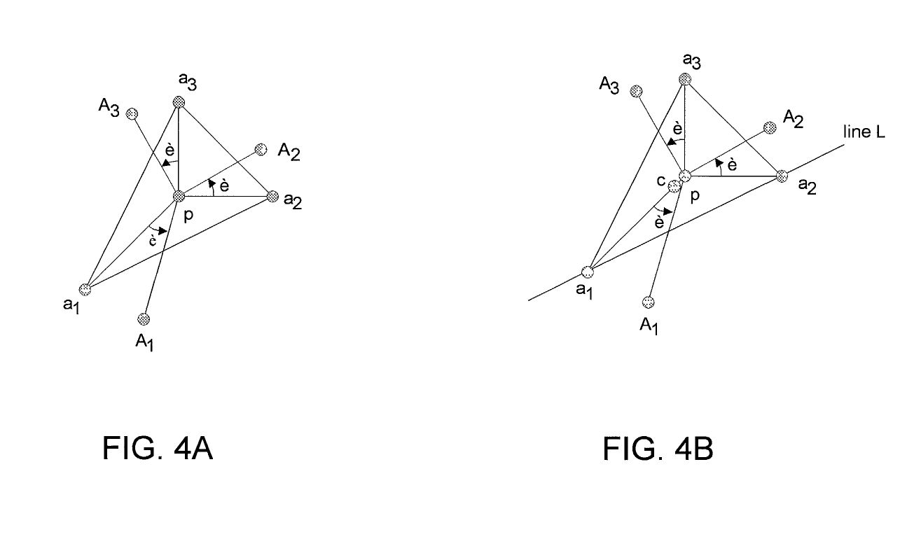

In FIG. 3E, the three fingers noted will “contact” virtual knob 130B at three points, denoted a1 (thumb tip position), a2 (forefinger tip position), and a3 (middle fingertip position). With reference to FIGS. 4A and 4B, analysis can be carried out by software 280 to recognize the rotation of virtual knob 130B that is shown in FIG. 3F, to recognize the magnitude of the rotation, and to translate such data into commands coupled via bus 330 to actual device(s) 70.

Consider the problem of determining the rotation angle Θ of virtual knob 130B given coordinates for three points a1, a2, and a3, representing perceived tips of user fingers before rotation. System 100 can compute and/or approximate the rotation angle Θ using any of several approaches. In a first approach, the exact rotation angle Θ is determined as follows. Let the pre-rotation (e.g., FIG. 3E position) points be denoted a₁=(x₁, y₁, z₁), a₂=(x₂, y₂, z₂), and a₃=(x₃, y₃, z₃) and let A₁=(X₁, Y₁, Z₁), A₂=(X₂, Y₂, Z₂), and A₃=(X₃, Y₃, Z₃) be the respective coordinates after rotation through angle θ as shown in FIG. 3F. In FIGS. 3E and 3F and 4A and 4B, rotation of the virtual knob is shown in a counter-clockwise direction.

Referring to FIG. 4A, the center of rotation may be considered to be point p=(xₚ, yₚ, zₚ), whose coordinates are unknown. The axis of rotation is approximately normal to the plane of the triangle defined by the three fingertip contact points a₁, a₂ and a₃. The (x,y,z) coordinates of point p can be calculated by the following formula:

$$[ \begin{matrix}{x}_{p} \\ {y}_{p} \\ {z}_{p}\end{matrix} ] = {\frac{1}{2} [ \begin{matrix}{X}_{1} - {x}_{1} & {Y}_{1} - {y}_{1} & {Z}_{1} - {z}_{1} \\ {X}_{2} - {x}_{2} & {Y}_{2} - {y}_{2} & {Z}_{2} - {z}_{2} \\ {X}_{3} - {x}_{3} & {Y}_{3} - {y}_{3} & {Z}_{3} - {z}_{3}\end{matrix} ]}^{- 1} [ \begin{matrix}{X}_{1}^{2} + {Y}_{1}^{2} + {Z}_{1}^{2} - {x}_{1}^{2} - {y}_{1}^{2} - {z}_{1}^{2} \\ {X}_{2}^{2} + {Y}_{2}^{2} + {Z}_{2}^{2} - {x}_{2}^{2} - {y}_{2}^{2} - {z}_{2}^{2} \\ {X}_{3}^{2} + {Y}_{3}^{2} + {Z}_{3}^{2} - {x}_{3}^{2} - {y}_{3}^{2} - {z}_{3}^{2}\end{matrix} ]$$

If the rotation angle θ is relatively small, angle θ can be calculated as follows:

$$θ = \sqrt{\frac{{X}_{i}^{2} + {Y}_{i}^{2} + {Z}_{i}^{2} - {x}_{i}^{2} - {y}_{i}^{2} - {z}_{i}^{2}}{{( {x}_{i} - {x}_{p} )}^{2} + {( {y}_{i} - {y}_{p} )}^{2} + {( {z}_{i} - {z}_{p} )}^{2}}}$$

$$for i = 1 , 2 , or 3.$$

Alternatively, system 100 may approximate rotation angle Θ using a second approach, in which an exact solution is not required. In this second approach, it is desired to ascertain direction of rotation (clockwise or counter-clockwise) and to approximate the magnitude of the rotation.

Referring now to FIG. 4C, assume that point c=(cₓ, c_{y}, c_{z}) is the center of the triangle defined by the three pre-rotation points a₁, a₂ and a₃. The following formula may now be used:

$$\{ \begin{matrix}{c}_{x} = \frac{{x}_{1} + {x}_{2} + {x}_{3}}{3} \\ {c}_{y} = \frac{{y}_{1} + {y}_{2} + {y}_{3}}{3} \\ {c}_{z} = \frac{{z}_{1} + {z}_{2} + {z}_{3}}{3}\end{matrix}$$

Again, as shown in FIG. 1, the z-axis extends from system 100, and the x-axis and y-axis are on the plane of the array of pixel diode detectors 140. Let L be a line passing through points a₁, a₂, and let L_{xy} be the projection of line L onto the x-y plane. Line L_{xy} may be represented by the following equation:

$$L ( x , y ) ≡ \frac{{y}_{1} - {y}_{2}}{{x}_{2} - {x}_{1}} ( x - {x}_{1} ) + y - {y}_{1} = 0$$

The clockwise or counter-clockwise direction of rotation may be defined by the following criterion:

Rotation is clockwise if L(cₓ,c_{y})·L(X₂,Y₂)<0, and rotation is counter-clockwise if L(cₓ, c_{y})·L(X₂, Y₂)>0.

When L(cₓ, c_{y})·L(X₂, Y₂)=0, a software algorithm, perhaps part of routine(s) 290, executed by computer sub-system 210 selects points a₂, a₃, passes line L through points a₂, a₃, and uses the above criterion to define the direction of rotation. The magnitude of rotation may be approximated by defining dᵢ, the distance between aᵢ, and Aᵢ, as follows:

dᵢ=\sqrt{(Xᵢ−xᵢ)²+(Y₁−y₁)²+(Zᵢ−zᵢ)²} for i=1,2,

The magnitude of the rotation angle Θ may be approximated as follows:

θ≈k(d₁+d₂+d₃),

where k is a system constant that can be adjusted.

The analysis described above is somewhat generalized to enable remote tracking of rotation of any three points. A more simplified approach may be used in FIG. 3E, where user 30 may use a fingertip to point to virtual indentation 310 in the image of circular knob 130B. The fingertip may now move clockwise or counter-clockwise about the rotation axis of knob 130B, with the result that system 100 causes the image of knob 130B to be rotated to track the user's perceived intended movement of the knob. At the same time, an actual controlled parameter on device 70 (or vehicle 20) is moved, proportionally to the user movement of the knob image. As in the other embodiments, the relationship between user manipulation of a virtual control and variation in an actual parameter of an actual device may be linear or otherwise, including linear in some regions of control and intentionally non-linear in other regions.

Software 290 may of course use alternative algorithms, executed by computer system 210, to determine angular rotation of virtual knobs or other images rendered by computing system 210 and projected via lens 190 onto windshield or other area 50. As noted, computing system 210 will then generate the appropriate commands, coupled via bus 330 to device(s) 70 and/or vehicle 20.

FIGS. 3G and 3H depict use of the present invention as a virtual training tool in which a portion of the user's body is immersed in the virtual display. In this application, the virtual display 40′ may be presented on a conventional monitor rather than in an HUD fashion. As such, system 100 can output video data and video drive data to a monitor, using techniques well known in the art. For ease of illustration, a simple task is shown. Suppose the user, whose hand is depicted as 302, is to be trained to pick up an object, whose virtual image is shown as 130H (for example a small test tube containing a highly dangerous substance), and to carefully tile the object so that its contents pour out into a target region, e.g., a virtual beaker 130I. In FIG. 3G, the user's hand, which is detected and imaged by system 100, is depicted as 130G in the virtual display. For ease of illustration, virtual hand 130G is shown as a stick figure, but a more realistic image may be rendered by system 100. In FIG. 3H, the user's real hand 302 has rotated slightly counter-clockwise, and the virtual image 40′ shows virtual object 130H and virtual hand 130G similarly rotated slightly counter-clockwise.

The sequence can be continued such that the user must “pour out” virtual contents of object 130H into the target object 130I without spilling. System 100 can analyze movements of the actual hand 302 to determine whether such movements were sufficiently carefully executed. The virtual display could of course depict the pouring-out of contents, and if the accuracy of the pouring were not proper, the spilling of contents. Object 130H and/or its contents (not shown) might, for example, be highly radioactive, and the user's hand motions might be practice to operate a robotic control that will grasp and tilt an actual object whose virtual representation is shown as 130H. However use of the present invention permits practice sessions without the risk of any danger to the user. If the user “spills” the dangerous contents or “drops” the held object, there is no harm, unlike a practice session with an actual object and actual contents.

FIG. 3I depicts the present invention used in another training environment. In this example, user 302 perhaps actually holds a tool 400 to be used in conjunction with a second tool 410. In reality the user is being trained to manipulate a tool 400′ to be used in conjunction with a second tool 410′, where tool 400′ is manipulated by a robotic system 420, 430 (analogous to device 70) under control of system 100, responsive to user-manipulation of tool 400. Robotically manipulated tools 400′, 410′ are shown behind a pane 440, that may be a protective pane of glass, or that may be opaque, to indicate that tools 400′, 410′ cannot be directly viewed by the user. For example, tools 400′, 410′ may be at the bottom of the ocean, or on the moon, in which case communication bus 330 would include radio command signals. If the user can indeed view tools 400′, 410′ through pane 440, there would be no need for a computer-generated display. However if tools 400′, 410′ cannot be directly viewed, then a computer-generated display 40′ could be presented. In this display, 130G could now represent the robotic arm 420 holding actual tool 400′. It is understood that as the user 302 manipulates tool 400 (although manipulation could occur without tool 400), system 100 via bus 330 causes tool 400′ to be manipulated robotically. Feedback to the user can occur visually, either directly through pane 440 or via display 40′, or in terms of instrumentation that in substantial real-time tells the user what is occurring with tools 400, 410′.

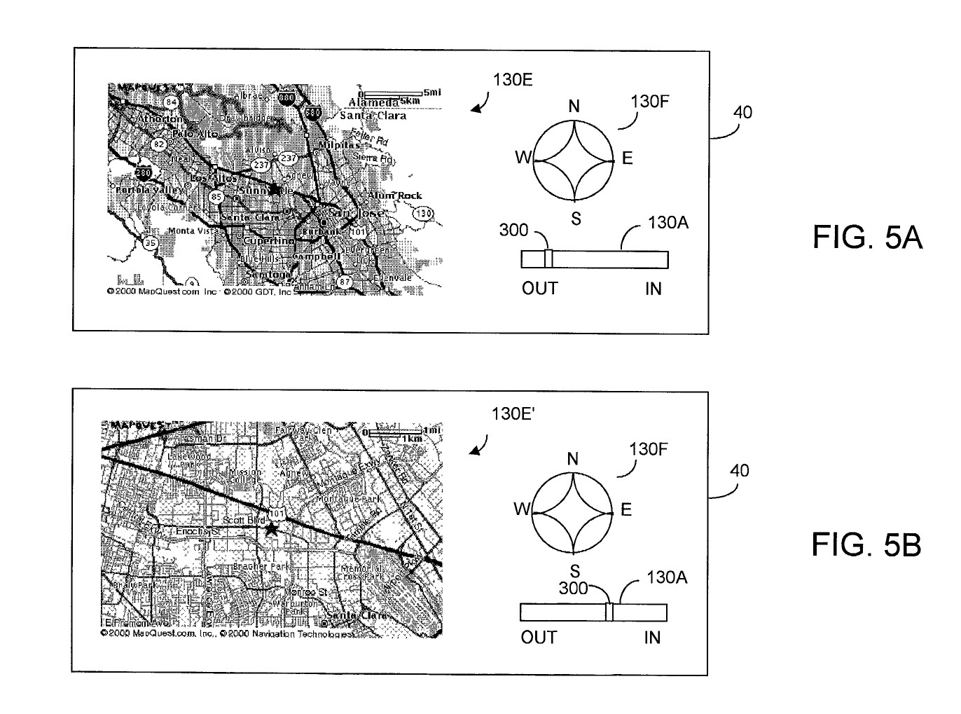

Thus, a variety of devices 70 may be controlled with system 100. FIG. 5A depicts a HUD virtual display created and projected by system 100 upon region 40 of windshield 50, in which system 70 is a global position satellite (GPS) system, or perhaps a computer storing zoomable maps. In FIG. 5A, image 130E is shown as a roadmap having a certain resolution. A virtual scroll-type control 130F is presented to the right of image 130E, and a virtual image zoom control 130A is also shown. Scroll control 130F is such that a user's finger can touch a portion of the virtual knob, e.g., perhaps a north-east portion, to cause projected image 130E to be scrolled in that compass direction. Zoom control 130A, shown here as a slider bar, permits the user to zoom the image in or out using a finger to “move” virtual slider bar 300. If desired, zoom control 130A could of course be implemented as a rotary knob or other device, capable of user manipulation.

In FIG. 5B, the user has already touched and “moved” virtual slider bar 300 to the right, which as shown by the indica portion of image 130A has zoomed in image 130E. Thus, the image, now denoted 130E, has greater resolution and provides more details. As system 100 detects the user's finger (or pointer or other object) near bar 300, detected three-dimensional (x,y,z) data permits knowing what level of zoom is desired. System 100 then outputs on bus 330 the necessary commands to cause GPS or computer system 70 to provide a higher resolution map image. Because system 100 can respond substantially in real-time, there is little perceived lag between the time the user's finger “slides” bar 300 left or right and the time map image 130E is zoomed in or out. This feedback enables the user to rapidly cause the desired display to appear on windshield 50, without requiring the user to divert attention from the task of driving vehicle 20, including looking ahead, right through the images displayed in region 40, to the road and traffic ahead.

Modifications and variations may be made to the disclosed embodiments without departing from the subject and spirit of the invention as defined by the following claims.

What is claimed is:

1. A method of presenting a virtual simulation to control an actual device, the method comprising the following steps:
(a) generating a display including an image of a control to change a parameter of said device,
(b) sensing (x,y,z) axes proximity of a user to said image on said display;
(c) determining non-haptically from data sensed at step (b), user intended movement of said image of said control; and
(d) outputting a signal coupleable to said actual device to control said parameter as a function of sensed user intended movement of said image of said control.

2. The method of claim 1, wherein at step (a), said display is a heads-up-display.

3. The method of claim 1, wherein step (b) includes sensing using time-of-flight data.

4. The method of claim 1, wherein step (c) includes modifying said display to represent movement of said control created by said user.

5. The method of claim 1, wherein step (a) includes generating an image of a slider control.

6. The method of claim 1, wherein step (a) includes generating an image of a rotary control.

7. The method of claim 1, wherein step (a) includes generating an image including a menu of icons selectable by said user.

8. The method of claim 1, wherein said actual device is selected from a group consisting of (i) an electronic entertainment device, (ii) radio, (iii) a cellular telephone, (iv) a heater system, (v) a cooling system, (vi) a motorized system.

9. The method of claim 1, wherein at step (a) said display is generated only after detection of a user in close proximity to an area whereon said display is presentable.

10. The method of claim 9, further including displaying a user-alert warning responsive to a parameter of said device, independently of user proximity to said area.

11. The method of claim 1, wherein said display is a heads-up-display in a motor vehicle operable by a user, and said device is selected from a group consisting of (i) said motor vehicle, and (ii) an electronic accessory disposed in said motor vehicle.

12. The method of claim 11, wherein said device is a global position satellite system, said display includes a map, and said control is user-operable to change displayed appearance of said map.

13. A method of presenting a virtual simulation, the method comprising the following steps:
(a) generating a display including a virtual image of an object;
(b) non-haptically sensing in three-dimensions proximity of at least a portion of a user's body to said display;
(c) modifying said display substantially in real-time to include a representation of said user's body; and
(d) modifying said display to depict substantially in real-time said representation of said user's body manipulating said object.

14. The method of claim 13, wherein said manipulating is part of a regime to train said user to manipulate a real object represented by said virtual image.

15. A virtual simulation system, comprising:
an imaging sub-system to generate a display including an image;
a detection sub-system to non-haptically detect in three-dimensions proximity of a portion of an object to a region of said display; and
said imaging sub-system modifying said image in response to detected proximity of said portion of said object.

16. The system of claim 15, wherein said image is a representation of a control, said object is a portion of a user's hand, and said proximity includes user manipulation of said image; further including:
a system outputting a signal coupleable to a real device having a parameter variable in response to said user manipulation of said image.

17. The system of claim 15, wherein:
said system is a heads-up-system;
said display is presentable on a windshield of a motor vehicle; and
said image includes an image of a control.

18. The system of claim 17, wherein:
said system includes a circuit outputting a command signal responsive to said detection of said proximity, said command signal coupleable to a device selected from a group consisting of (a) an electrically-controllable component of said motor vehicle, (b) an electrically-controllable electronic device disposed in said motor vehicle.

19. The system of claim 18, wherein said device is a global positioning satellite (GPS) system, wherein said image is a map generated by said GPS system, and said image is a control to change appearance of said image of said map.

20. The system of claim 17, wherein said detection sub-system operates independently of ambient light.
